(19) United States
(12) Patent Application Publication
(10) Pub. No.: US 2006/0081561 A1
(43) Pub. Date: Apr. 20, 2006

(54) Lighted clip-on toy with consumable portion

(76) Inventors: Lydia Lopez-Ethnasois, St. George, UT (US); Alex C. Tam, Laguna City (HK); Kami Gillmour-Bryant, Canyon Country, CA (US)

Correspondence Address: CHRISTIE, PARKER & HALE, LLP, PO BOX 7068, PASADENA, CA, 91109-7068, US

(21) Appl. No.: 11/203,389

(22) Filed: Aug. 12, 2005

Related U.S. Application Data
(63) Continuation-in-part of application No. 10/757,112, filed on Jan. 13, 2004.
(60) Provisional application No. 60/628,511, filed on Nov. 15, 2004.

(51) Int. Cl. B23K 31/02

(52) U.S. Cl. 219/61

(57) ABSTRACT

A clip-on toy with a consumable portion having a housing containing a power source and an electrical circuit, the housing having a stem for supporting the consumable portion; a clip portion for removably attaching the clip-on toy to other objects; a connecting portion extending between the housing and the clip portion for connecting the clip portion to the housing; and an illuminating element disposed within the stem connectable to the power source through the electrical circuit to illuminate the consumable portion.

### CROSS-REFERENCE TO RELATED APPLICATION

This application is a continuation-in-part of U.S. patent application Ser. No. 10/757,112, filed Jan. 13, 2004 and entitled LIGHTED RING TOY WITH CONSUMABLE PORTION and claims the benefit of the filing date of U.S. provisional patent application No. 60/628,511, filed Nov. 15, 2004 and entitled LIGHTED CLIP-ON TOY WITH CONSUMABLE PORTION, the contents of which are hereby incorporated by reference.

### BACKGROUND OF THE INVENTION

Lighted toys containing candies or other consumable substances have been provided. However, such toys do not allow the user to readily attached the toy to another object, such as a backpack or a bag. Further, such toys may be lather large and complex and therefore may be expensive to manufacture.

### SUMMARY OF THE INVENTION

The present invention relates to a lighted toy that entertains a user while a consumable supported by the toy is consumed. The user activates the lighting feature of the toy by removing a circuit-interrupting insulator. Once the insulator is removed and the circuit is closed, a power source causes a light source located inside a housing to illuminate the consumable for a period of time required for the user to consume at least a portion of the consumable. The device is simple and inexpensive to manufacture.

In one embodiment of the invention, the lighted toy of the invention is a clip-on toy and has: a housing containing a power source and an electrical circuit, the housing having a stem for supporting a consumable portion; a connecting portion extending between the housing and the clip portion for removably attaching the clip-on toy to another object; and an illuminating element connectable to the electrical circuit and the power source to illuminate the consumable portion.

In a particular embodiment, the electrical circuit may have a least one electrical contact for completing the circuit in a contacting position thereof, and the ring toy may further comprise a removable insulator disposed adjacent the electrical contact in a non-contacting position to interrupt the electrical circuit. The power source may be configured to illuminate the consumable portion for a preselected period of time sufficient to consume the consumable portion, and thereafter to expire.

### BRIEF DESCRIPTION OF THE DRAWINGS

The present invention may be more readily understood from the following specification and by reference to the accompanying drawings, wherein:

FIG. 1 is a perspective view of a clip-on toy according to an embodiment of the present invention;

FIG. 2 is an exploded perspective view of the toy of FIG. 1;

FIG. 3 is a vertical cross-sectional view of the toy taken along the line 3-3 in FIG. 1 according to one embodiment of the present invention;

FIG. 4 is a top plan view of a lower portion of the housing of the toy, as seen in the direction 4-4 of FIG. 3;

FIG. 5 is a schematic of the electrical circuit of the lighted toy of FIG. 1 in the illustrated embodiment of the invention utilizing a flashing light emitting diode (LED);

FIG. 6 is a schematic of a configuration of the electrical circuit of the invention in another embodiment utilizing a non-flashing LED and a separate flasher circuit;

FIG. 7 is a side elevated view of the lighted toy of FIG. 1 having a cover thereon, the cover shown in cross section; and

FIGS. 8A-8E illustrate alternative possible designs of the consumable according to various embodiments of the present invention.

### DETAILED DESCRIPTION

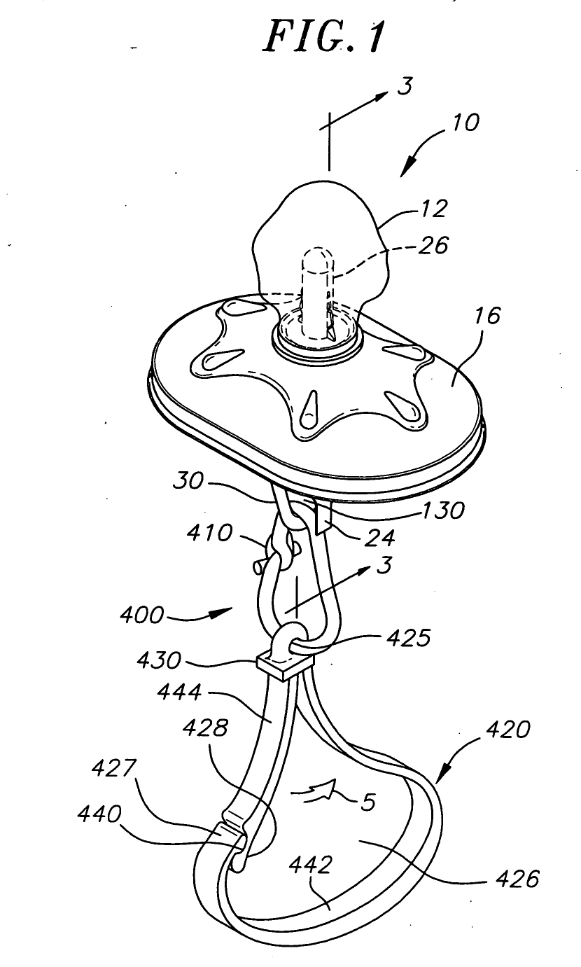

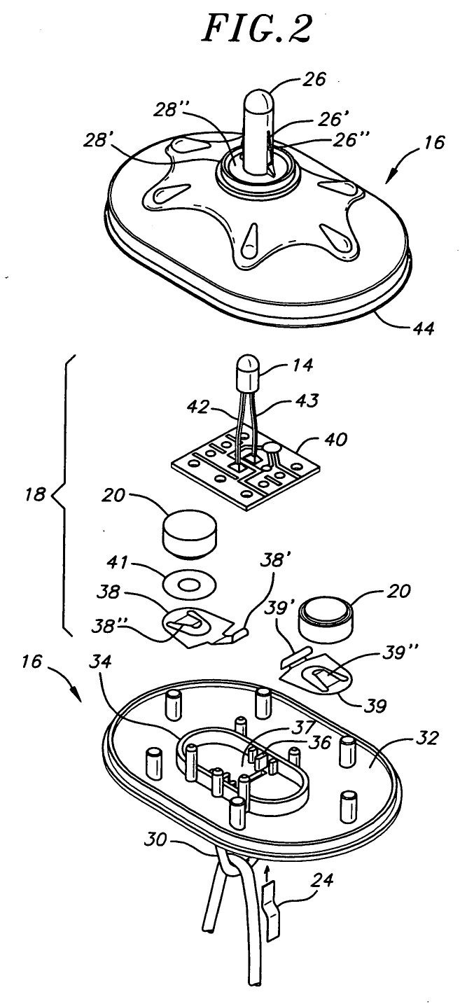

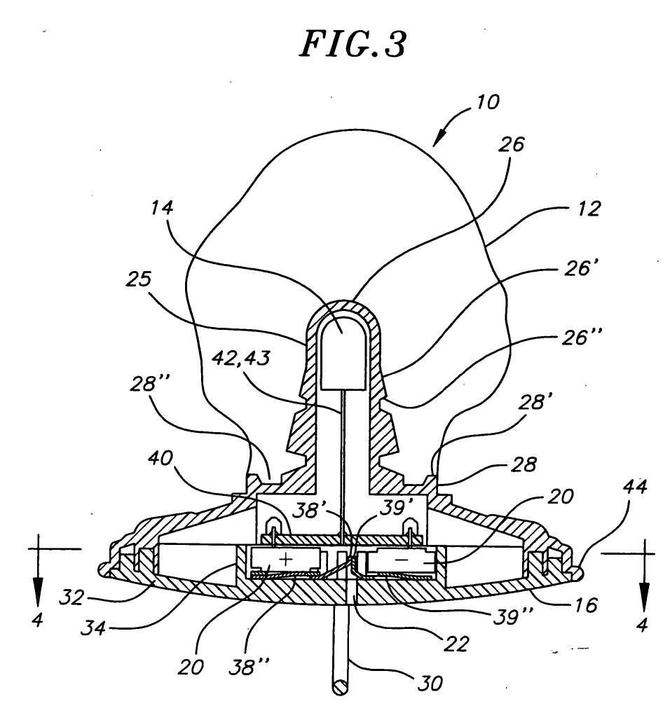

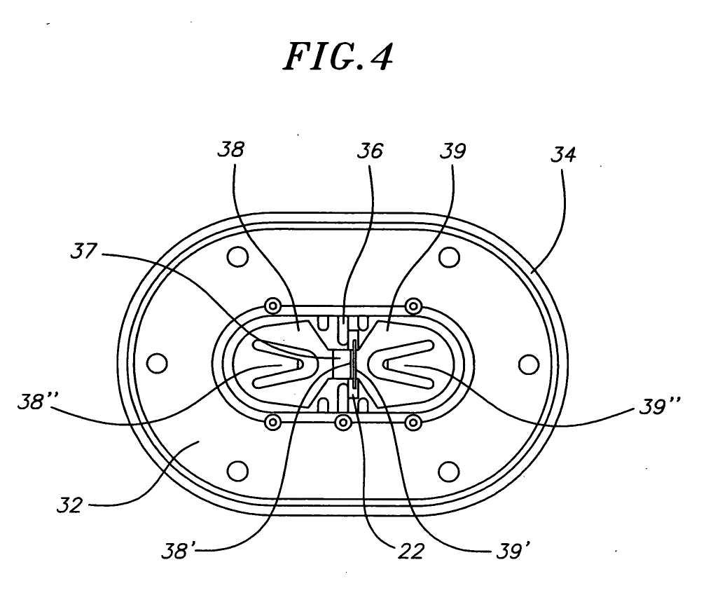

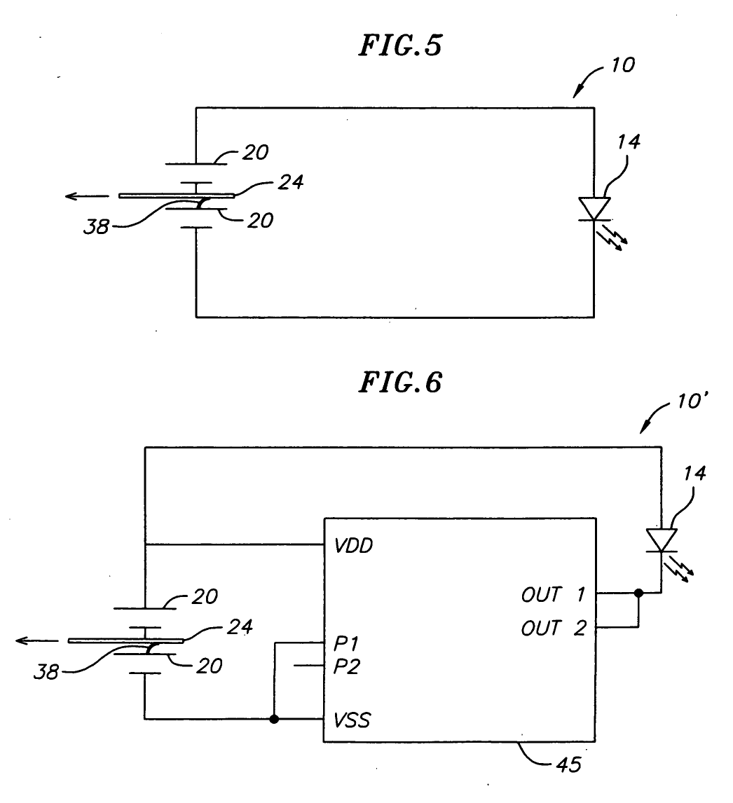

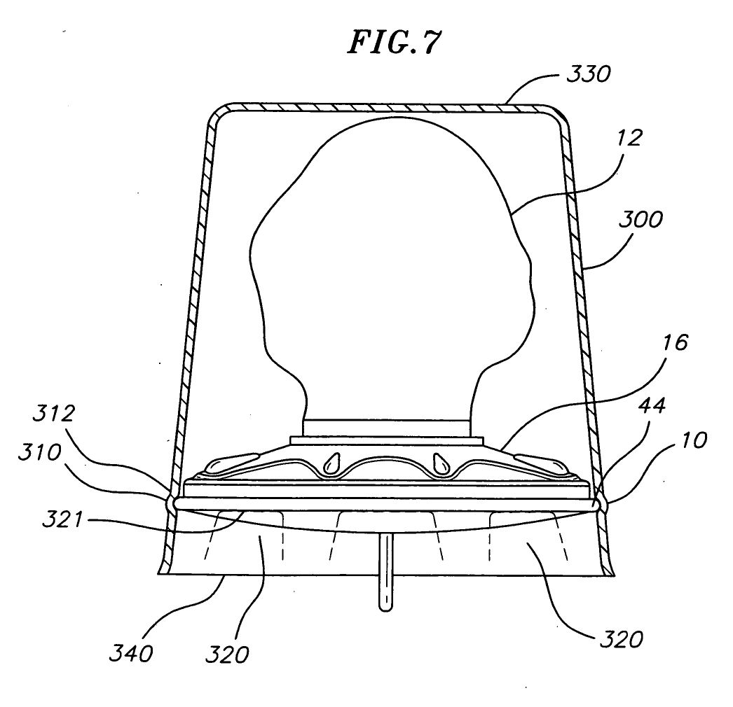

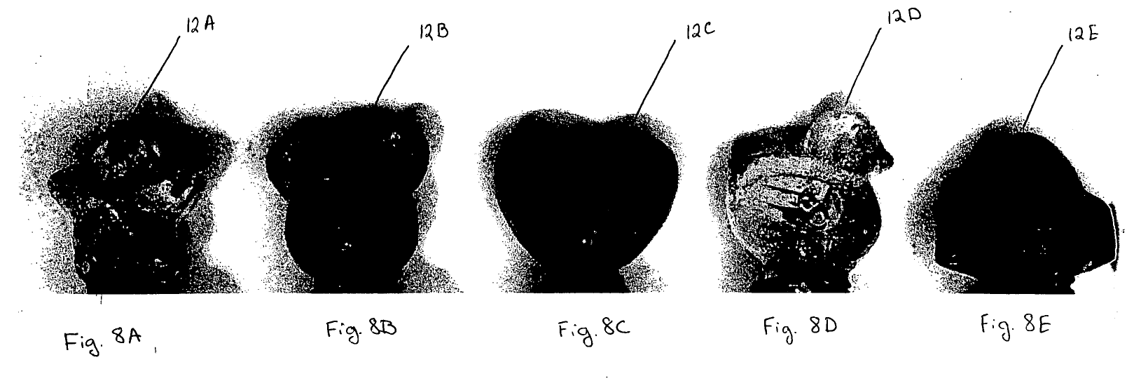

Referring now to the drawings, FIGS. 1, 2, and 3 illustrate a lighted clip-on toy 10 according to one embodiment of the invention. The clip-on toy 10 is constructed to be clipped on or attached to another object and includes a consumable 12 (FIG. 1) illuminated by a battery-powered light source 14 (FIG. 2). In the illustrated embodiment, the light source 14 is contained within a housing 16 upon which the consumable 12 is mounted. The housing 16 contains an electrical circuit 18 and a power source 20 which cause the illumination effect to occur. The housing 16 has an opening 22 (FIG. 3) through which a removable insulator 24 passes to interrupt the electrical circuit 18. Removal of the insulator 24 allows the electrical circuit 18 to be completed, creating the illumination effect of the toy and thereby amusing a user during consumption of the consumable 12 and/or while the clip-on toy is attached to another device.

The consumable 12 mounted on the toy can be sucker candy, gummy candy, or any other food product through which illumination of the light source 14 can be seen to amuse the user. It can also have a wide variety of shapes and colors intended to amuse the user when it is illuminated. A few examples of the shapes for the consumable 12 are illustrated in FIGS. 8A through 8E and identified by the numerals 12A through 12E, respectively.

The consumable 12 has an opening 25 (FIG. 3) that receives a stem 26 of the housing 16 to hold the consumable 12 in place. The stem 26 preferably has a plurality of inclined ribs 26′ on its outer surface with undercut portions 26″ to ensure that the consumable 12 remains in place at the housing 16 during consumption or use. Alternatively, other surface structures can be employed to ensure that the consumable 12 remains in place at the housing 16 during consumption or use. When a resilient material, such as gummy candy is used for the consumable 12, the opening 25 in the consumable may be somewhat smaller in diameter than the portion of the housing to be received within it to enhance friction and thereby retain the candy in place.

The light source 14 can be a light emitting diode (“LED”) or any other suitable device for producing light in response to electrical power from the power source 20. The light source 14 can be of either the flashing or non flashing type.

Referring more specifically to FIGS. 2 and 3, in the illustrated embodiment, the stem 26 of the housing 16 contains the light source 14 and supports the consumable 12. While the material of at least a part of the stem 26 is limited by the need to allow at least a portion of the light emanating from the light source to pass through it to achieve the desired visual effect, the remainder of the housing 16 is not so limited and can be made of any other suitable material.

Although the figures show a particular shape for the stem 26, alternatively, it can have any other shape suitable for supporting the consumable 12 and housing the light source 14.

Moreover, it will be understood that the stem 26 (which may also be referred to as an upwardly-extending portion) may point in any direction, including downward, when the toy is being used or consumed. For example, according to one embodiment of the invention, shown in FIG. 1, the toy is to be hung from a backpack or bag of the user, whereby the stem 26 will point downward. The term “upwardly-extending portion” may be used for ease of reference to the Figures, wherein the stem 26 of the housing 16 is shown in an upwardly-extending position.

As shown in FIG. 2, the housing may be made of two different parts joined together to contain the power source 20, the electrical circuit 18, and the light source 14 of the toy 10. These two parts can be joined together by a snapping structure, by an adhesive, by combination thereof or by any other suitable method. In the embodiment shown in FIG. 3 the top portion of the housing 16 has an outer lip 44, for joining with the lower portion of the housing 16.

Referring to FIG. 3, in the illustrated embodiment, the housing 16 includes a boss 28 at the base of the stem 26 for supporting the consumable 12. The boss 28 has a peripheral lip 28′ that engages the outer edge of the consumable 12, giving the combination a pleasing, uniform appearance and securing the consumable 12 to the housing 16. In some cases, an interior void 28″ is provided adjacent the base of the stem 26 to permit contraction of the candy upon curing. The housing 16 can be shaped in any way that provides sufficient space for the electrical circuit 18, the power source 20, and the light source 14. The embodiment shown in the drawings comprises a form of an elliptical pyramid whose vertex is replaced by the stem 26 of the housing 16. This gives the housing an enlarged lateral dimension.

A connecting portion 30 (or a “loop” portion) of the embodiment shown in the Figures extends from the bottom of the housing 16. The bottom of the housing 16 includes a horizontal plate 32 that joins with the remainder of the housing to support the electrical circuit 18 and the power source 20. A race track shaped abutment 34 extends upward from the horizontal plane 32 to hold in place the power source 20, represented in the drawings by two button cell batteries. The abutment 34 includes two inward extensions 36 (FIG. 4) that create a pair of recesses for receiving the button cell batteries, and a narrow gap 37 (FIGS. 2 and 4) along the floor of the plate 32.

As seen in FIG. 4, first and second contact portions 38 and 39 are disposed within the recess directly below the batteries. The first contact portion 38 has a finger 38′ which extends through the gap 37 to the vertical tab 39′ of the second contact portion 39. The two contact portions are also provided with central spring arms 38″ and 39″, respectively, which urge the batteries upwardly. The finger 38′ of the contact portion 38 is configured to make contact with the tab 39′ of the contact portion 39 when the insulator 24 is removed from the opening 22.

In the embodiment shown in the figures, the button cell batteries are disposed in opposite directions so that they are connected in series with each other and with the light source 14 when the first contact portion 38 touches the contact portion 39. To avoid shorting out the battery terminals, an insulator ring 41 of insulating material is disposed underneath the inverted battery along its peripheral edge. The light source 14 is connected to the batteries by leads 42 and 43, which pass through and are attached to a small circuit board or wiring board 40 for support. The ends of the leads 42 and 43 extend from, or pass through, the bottom of the circuit board 40 where they make electrical contact with opposite poles of the two batteries. The electrical circuit 18, therefore, comprises the light source 14, the power source 20, the first and second contact portions 38 and 39, and the leads 42 and 43.

The board 40 can vary in complexity in different embodiments of the invention. In the embodiment of FIGS. 1-3, the board 40 merely anchors the leads 42 and 43 and support the light source 14. In that case, the schematic of the lighted ring toy 10 can be as illustrated in FIG. 5. The light source 14 may then be a flashing LED of the type available under the commercial designation MT-F406, which is powered by two series-connected batteries of the type identified commercially as 392A LR41 button cells. In This embodiment, the LED 14 is connected across the series-connected batteries 20 such that the removal of the insulator strip 24 in the direction indicated will complete the circuit and cause the LED to flash until the batteries are discharged.

According to the schematic of FIG. 6, which depicts an alternative embodiment of the invention (10′), the board 40 may comprise a circuit 45 that provides, in addition to physical support, lighting effects such as flashing of the light source 14. In this embodiment, the circuit 45 may be an integrated circuit of the type available commercially under designation A5403-01 which, in the illustrated configuration, intermittently applies the voltage of the batteries 20 across the LED 14 to produce a flashing light effect. Accordingly, in this embodiment, the light source can be a non-flashing LED available commercially under the designation 3R4SDB-4.

Now considering the battery circuit in greater detail, the negative terminal of each button cell battery is the discrete circular terminal on one of its ends, and the positive terminal includes the sides and bottom surfaces of the battery. One battery is inverted relative to the other, and the central spring arm 38″ of the contact portion 38 contacts the negative terminal of the inverted battery, while the positive terminal is separated from the contact portion 38 by the insulator ring 41. In this configuration, the finger 38′ of the first contact portion 38 is urged toward the tab 39′ of the second contact portion 39, which is in contact with the positive terminal of the non-inverted battery, but is initially prevented from contacting it by the insulator 24. Removal of the insulator 24 allows the finger 38′ to touch the tab 39′, completing the circuit to apply the combined voltages of the two batteries across the leads of the light source 14.

The contact portions 38 and 39 may be made of copper, steel or other resilient conductive material, causing the finger 38′ to press against the insulator 24 with sufficient force to hold it in place, while, at the same time, permitting the insulator 24 to be removed by manually puling it downwardly from the housing 16, in the direction opposite to the stem 26. In one embodiment, the first elongated contact portion 38 is rounded or bent at its point of contact with the insulator 24 so that the insulator 24 can be removed without tearing or becoming jammed in the housing 16.

The insulator 24 and the insulator ring 41 may be made of any suitable insulating material, such as coated paper or a sheet of suitable synthetic polymeric material. In one particular embodiment, the material may be the type available commercially under the trademark Mylar.

In a further embodiment, shown in FIG. 7, a cover 300 is provided for connecting with the housing 16 and, thereby, reducing the likelihood of consumable 12 becoming dirty from contact with various objects. The bottom portion of the cover 300 contains grooves 310 and notches 312 for engaging with the lip 44 of the housing 16. The lower portion of the cover 300 further contains at least two indents 320, on which the bottom of the housing 16 can rest when the cover 300 is placed over the consumable 12. In this manner, the lip 44 of the housing 16 is secured in the grooves 310 between the notches 314 and the top portions 321 of the indents 320. The top 330 of the cover 300 is adjacent to the top of the consumable 12.

The cover 300 can be made of any suitable material, such as plastic, and is of a generally cylindrical shape; however, the area of the top 330 is smaller than the area of a bottom side 340. The bottom side 340 is open to receive the toy; while the top 330 is closed. In this manner, when the cover is 300 is in place, a closed space is formed by the bottom of the housing 16, the sides of the cover 300, and the top 330, said space housing the consumable 12.

As shown in FIGS. 1 and 2, the loop portion 30, according to the shown embodiments, extends from the bottom of the housing 16. The loop portion 30 forms an opening 130 with the bottom of the housing 16. In the shown embodiments, the loop portion 30 is generally of a shape of letter U or an inverted bell. Alternatively, the loop portion 30 can be of any shape to form an opening with the bottom of the housing 16 for receiving a connecting portion for attaching a clip 420. It will be appreciated that the connecting portion attaching the clip 420 may be connected to the housing 16 by any other means.

According to the shown embodiment of the present invention, the loop portion 30 of the housing 16 receives a cord 400 which is connected to the clip 420 for clipping the toy to other objects. In this embodiment, the cord 400 is the connecting portion for connecting the housing 16 to the clip 420. The cord 400 is passed through a top hole 425 of the clip 420 and the opening 130 formed by the loop portion 30 with the housing 16. The ends of the cord 400 are tied together in a knot or a double-knot 410. Alternatively, the two ends of the cord 400 can be fastened by means of a clasp, a fastener, a latch, two buckles, or the like. Any feasible method of fastening the two ends of the cord 400 which connect the clip 420 to the toy can be used. The cord 400 can be made of a string, a short piece of rope, a small chain, a plastic or rubber lace, or any other material suitable for inexpensively connecting the clip 420 to the housing 16.

The clip 420, shown in FIG. 1, includes the top hole 425 and a larger bottom hole 426. The lower portion of the clip 420, and accordingly the hole 426, is of generally a teardrop shape, with curved sides and a rounded bottom portion. In the shown embodiment, a horizontal plane 430 is provided between the lower portion of the clip 420 and the top portion, for structural stability. The clip 420 has a break 440 for allowing the user to attach, or “clip on”, the clip 420, and thereby the toy 10, to a backpack or another object. According to the shown embodiment, the clip 420 has a flexible portion 444 and a fixed portion 442. The flexible portion 444 is resiliently biased against the fixed portion 442. The end of the fixed portion 442 at the break 440 contains a notch 427 for engaging with a corresponding groove 428 in the flexible portion 444 near the break 440. The notch 427 engages the groove 428 to form a secure connection under the influence of the spring characteristics of the clip 420.

In this embodiment of the invention, the flexible portion 444 moves between a first (“closed”) position, where it contacts the fixed portion 442 to form a continuous loop, closing the clip 420, and a second (“open”) position, where the flexible portion 444 is spaced from the fixed portion 442 to form an open loop thereby opening the clip 420. The flexible portion 444 is biased toward the closed position, where it is resiliently urged against the fixed portion 442, and can be moved to the open position by the user applying force in the direction 5 shown in FIG. 1. It will be appreciated by those skilled in the art that the clip 420 can be any commercially available device which would allow the toy 10 to be easily and inexpensively attached to an object, such as a backpack, a belt loop, or the like.

To operate the embodiment of the invention according to FIGS. 1 and 2, the user clips the toy onto another object, such as a backpack, a belt loop, pants, or any other object with a suitable location for removably attaching the clip 420. The user may then remove the strip 24 to activate the flashing lights effect for amusement. The user may also remove the toy by unclipping the clip 420 and consume the consumable portion 12.

The preceding description has been presented with reference to presently preferred embodiments of the invention. These should not be construed as limitations on the scope of the invention, but rather, as examples of the embodiments thereof. Alterations and changes in the described structure may be practiced without meaningfully departing from the scope and spirit of the invention.

For example, the circuit board 40 may, in its more complex embodiments, take the form of a printed circuit board having discrete electronic components mounted thereon, an integrated circuit, or a hybrid circuit comprising both discrete components and one or more integrated circuits. Accordingly, the scope of the invention should be determined not by the embodiments illustrated, but by the appended claims and their equivalents.

What is claimed is:

1. A clip-on toy with consumable portion comprising:
a housing containing a power source and an electrical circuit, the housing having a stem for supporting a consumable portion;
a clip portion for removably attaching the clip-on toy to other objects;
a connecting portion extending between the housing and the clip portion for connecting the clip portion to the housing; and
an illuminating element disposed within the stem connectable to the power source through the electrical circuit to illuminate the consumable portion.

2. The clip-on toy of claim 1 wherein the connecting portion comprises a cord for connecting the clip portion to the housing.

3. The clip-on toy of claim 1 wherein the clip portion comprises a fixed portion and a movable portion; the movable portion being movable between a first position, wherein the movable portion meets with the fixed portion to create a continuous loop, and a second position, wherein the movable portion is spaced from the fixed portion to form an open loop.

4. The clip-on toy of claim 3 wherein in the movable portion is resiliently biased against the flexible portion.

5. The clip-on toy of claim 1 wherein the stem allows at least a portion of light from the illuminating element to pass through it.

6. The clip-on toy of claim 1 wherein
the electrical circuit has at least one electrical contact for completing the electrical circuit in a contacting position thereof, and
the clip-on toy further comprises a removable insulator disposed adjacent the electrical contact in a non-contacting position to interrupt the electrical circuit.

7. The clip-on toy of claim 6 wherein the at least one electrical contact comprises a resilient electrical conductor mechanically biased relative to the power source to complete the electrical circuit in said contacting position thereof.

8. The clip-on toy of claim 6 wherein the power source is configured to illuminate the consumable portion for a preselected period of time sufficient to consume at least a portion of if, and thereafter to expire.

9. The clip-on toy of claim 8 wherein the circuit board includes at least one integrated circuit configured as a flasher.

10. The clip-on toy of claim 6 wherein the removable insulator is made of coated paper.

11. The clip-on toy of claim 6 wherein the removable insulator comprises a synthetic polymeric material.

12. The clip-on-toy of claim 11 wherein the removable insulator comprises Mylar.

13. The clip-on toy of claim 1 wherein a circuit board is integrated into the electrical circuit to cause the illuminating element to flash.

14. The clip-on toy of claim 1 wherein the illuminating element is an LED of the flashing type.

15. The clip-on toy of claim 1 further comprising a cover for placing over the consumable portion, the cover being removably attachable to the housing.
